(19) United States
(12) Patent Application Publication
(10) Pub. No.: US 2025/0224376 A1
(43) Pub. Date: Jul. 10, 2025

(54) EDDY-CURRENT FLAW DETECTION DEVICE AND EDDY-CURRENT FLAW DETECTION METHOD

(71) Applicant: IHI Corporation, Tokyo (JP)

(72) Inventors: Atsuko NUMA, Tokyo (JP); Koichi INAGAKI, Tokyo (JP)

(73) Assignee: IHI Corporation, Tokyo (JP)

(21) Appl. No.: 19/089,284

(22) Filed: Mar. 25, 2025

Related U.S. Application Data
(63) Continuation of application No. PCT/JP2023/034624, filed on Sep. 25, 2023.

(30) Foreign Application Priority Data
Jan. 13, 2023 (JP) 2023-003836

(51) Int. Cl. G01N 27/90; G01N 27/9013

(52) U.S. Cl. CPC G01N 27/9053; G01N 27/902

(57) ABSTRACT

An eddy-current flaw detection device includes a storage unit that stores in advance a shape of a first object; and a probe that scans a component surface of the first object. The device includes a control unit that causes the probe to scan the component surface along a scanning path crossing an edge of the component surface. The device includes a first determination unit that determines a position of the edge in a scanning direction in which the scanning path P extends, based on an edge signal. The device includes a second determination unit that compares the position of the edge with a position of an edge of the first object stored in advance and determine a first offset amount in the scanning direction of the first object. The control unit offsets the scanning path in the scanning direction based on the first offset amount.

### CROSS-REFERENCE TO RELATED APPLICATIONS

The present application is a continuation application of International Application No. PCT/JP2023/034624, now WO 2024/150472 A1, filed on Sep. 25, 2023, which claims priority to Japanese Patent Application No. 2023-003836, filed on Jan. 13, 2023, the entire contents of which are incorporated by reference herein.

### BACKGROUND OF THE INVENTION

### Technical Field

The present disclosure relates to an eddy-current flaw detection device and eddy-current flaw detection method.

### Background Art

The inspection device disclosed in JP 5294773 B is an inspection device for inspecting a tangential recess in a rotor disk using eddy-current. The inspection device includes a probe having an outline that matches an outline of a cross section of the recess. The probe accommodates a plurality of sensors, which are arranged to acquire a plurality of data sequences in scanning along the longitudinal direction of the recess. The device includes a support having two positioning members that co-operate respectively with two recesses neighboring the recess for inspection, and moving equipment carrying the probe and arranged to guide it along the recess during inspection.

### CITATION LIST

### Patent Literature

Patent Literature 1: JP 5294773 B

### SUMMARY OF INVENTION

By the way, an eddy current flaw detection test has been performed to detect scratches on a surface of a metal component, for example. In the eddy current flaw detection test, a probe is scanned on a surface of a component to be inspected, and changes in eddy current generated on the surface are detected. Thus, scratches on the component surface can be detected. When a position of a component to be inspected or a position of a probe in the eddy-current flaw detection test is incorrectly determined, the result of the eddy-current flaw detection test may be inaccurate. Therefore, in order to determine the position of the component to be inspected or the position of the probe more accurately in advance, there has been cases where the complicated processes are performed. That is, the processes of the eddy-current flaw detection test may be complicated.

An eddy-current flaw detection device according to the present disclosure includes: a storage unit configured to store in advance a shape of a first object to be inspected; a probe configured to scan a component surface of the first object and to detect a change in eddy-current; a control unit configured to cause the probe to scan the component surface along a scanning path that crosses an edge of the component surface; a first determination unit configured to determine a position of the edge in a scanning direction in which the scanning path extends, based on an edge signal indicating the change in eddy-current caused by the edge; and a second determination unit configured to compare the position of the edge with a position of an edge of the first object stored in advance and to determine a first offset amount in the scanning direction of the first object; wherein the control unit offsets the scanning path in the scanning direction based on the first offset amount.

In the eddy-current flaw detection device, the edge signal may be detected by scanning the probe from a first region adjacent to an edge region extending along the edge on the component surface toward an outside of the edge across the edge region.

In the eddy-current flaw detection device, the first determination unit may determine, as the position of the edge in the scanning direction, a position where an intensity of the signal indicating the change in eddy-current becomes maximum when scanning the component surface with the probe along the scanning path.

In the eddy-current flaw detection device, the control unit may cause the probe to scan one side surface of a first portion and the other side surface thereof in the first direction, which form the first object, along the scanning path; and the first determination unit may determine the position of the edge in the scanning direction of each of the one side surface and the other side surface based on the edge signal.

In the eddy-current flaw detection device, the control unit may cause the probe to scan each first portion forming the first object along the scanning path, and the first determination unit may determine the position of the edge in the scanning direction of each first portion based on the edge signal.

The eddy-current flaw detection device may include: an imaging device configured to photograph the probe and to generate an image; and a recognition unit configured to detect the probe in the image generated by the imaging device and to recognize a position or posture of the probe; wherein the recognition unit may determine a second offset amount in a direction crossing the scanning direction of the probe by comparing the position at which the probe is detected in the image with a reference position of the probe therein, and the control unit may offset the scanning path in the direction crossing the scanning direction based on the second offset amount.

An eddy-current flaw detection method according to the present disclosure includes: storing in advance a shape of a first object to be inspected; by a probe, scanning a component surface of the first object and detecting a change in eddy-current; causing the probe to scan the component surface along a scanning path which crosses an edge of the component surface; determining a position of the edge in a scanning direction in which the scanning path extends, based on the edge signal indicating the change in eddy-current caused by the edge; comparing the position of the edge with a position of an edge of the first object stored in advance and determining a first offset amount in the scanning direction of the first object; and offsetting the scanning path in the scanning direction based on the first offset amount.

According to the present disclosure, it is possible to provide an eddy-current flaw detection device and an eddy-current flaw detection method capable of more easily performing an eddy-current flaw detection test.

### BRIEF DESCRIPTION OF DRAWINGS

FIG. 1 is a schematic perspective view showing an example of the overall configuration of an eddy-current flaw detection device according to an embodiment.

FIG. 2 is a schematic perspective view showing an inspection object of the eddy-current flaw detection device according to an embodiment.

FIG. 3 is a block view showing an example of the overall configuration of the eddy-current flaw detection device according to an embodiment.

FIG. 4 is a schematic view showing a probe of the eddy-current flaw detection device according to an embodiment.

FIG. 5 is a view for explaining a first recognition process performed in the eddy-current flaw detection device according to an embodiment, and is a schematic side view showing a positional relationship between a first imaging device and an inspection object.

FIG. 6 is a view for explaining a second recognition process performed in the eddy-current flaw detection device according to an embodiment, and is a schematic side view showing a positional relationship among a second imaging device, a light source, and a probe.

FIG. 7 is a view for explaining the second recognition process performed by the eddy-current flaw detection device according to an embodiment, and is an explanatory view showing an image of a probe photographed by the second imaging device.

FIG. 8 is a view for explaining a second recognition process performed by the eddy-current flaw detection device according to an embodiment, and is a schematic side view showing a positional relationship among the second imaging device, the light source, and the probe.

FIG. 9 is a view for explaining a first scanning process performed by the eddy-current flaw detection device according to an embodiment, and is a schematic perspective view showing a positional relationship between the first portion and the probe.

FIG. 10 is a view for explaining the first scanning process and a first determination process performed by the eddy-current flaw detection device according to an embodiment, and is an arrow-view viewed from the arrow A in FIG. 9 showing a positional relationship between a side surface of a first portion and the probe.

FIG. 11 is a view for explaining a first determination process performed by the eddy-current flaw detection device according to an embodiment, and is a graph showing an intensity of a signal indicating a change in eddy-current obtained when the side surface of the first portion and the space above it are scanned by the probe along a scanning path.

### DESCRIPTION OF EMBODIMENTS

Hereinafter, some exemplary embodiments will be described with reference to the drawings. Elements having the same function are denoted by the same reference numerals, and duplicate descriptions are omitted.

A X-axis direction in each figure is the direction in which a first slider 4a, which will be described later, can move, and the positive X-axis direction and the negative X-axis direction are referred to simply as the “X-axis direction”. A Y-axis direction is the direction in which a second slider 4b, which will be described later, can move, and the positive Y-axis direction and the negative Y-axis direction are referred to simply as the “Y-axis direction”. A Z-axis direction is the direction in which a third slider 4c, which will be described later, can move, and the positive Z-axis direction and the negative Z-axis direction are referred to simply as the “Z-axis direction”. The positive Z-axis direction corresponds to the upward direction, and the negative Z-axis direction corresponds to the downward direction. The X-axis direction, the Y-axis direction, and the Z-axis direction cross each other, and may be substantially orthogonal to each other, for example. A θ-axis direction is the direction of rotation around an axis A1, which will be described later, and the positive θ-axis direction and the negative-axis direction are referred to simply as the “θ-axis direction”. A P-axis direction is the direction of rotation about the extending direction of a probe shaft 7, which will be described later, and the positive P-axis direction and the negative P-axis direction are referred to simply as the “P-axis direction”. An R-axis direction is the direction of rotation around an axis A2 of a stage 6, which will be described later, and the positive R-axis direction and the negative R-axis direction are referred to simply as the “R-axis direction”.

The eddy-current flaw detection device and eddy-current flaw detection method according to the embodiment can be used for eddy-current flaw detection test. In the eddy-current flaw detection test, the presence or absence of defects, such as cracks, which exist in an electrically conductive inspection object can be inspected. The eddy-current flaw detection test is also called ET (Eddy-current testing).

In the eddy-current flaw detection test, an eddy-current is generated on a surface of the inspection object by forming a magnetic field on the surface of the inspection object with an excitation coil. Then, the magnetic field induced by the eddy-current is detected by a detection coil. When a defect exists on the surface of the inspection object, the flow path of the eddy-current changes due to the effect of the defect. As a result, the magnetic field induced by the eddy-current changes. By detecting such a change in the magnetic field by the detection coil, it is possible to determine whether a defect exists on the surface of the inspection object. That is, the state of the surface of the inspection object can be inspected by detecting a change in eddy-current caused by the presence or absence of defects.

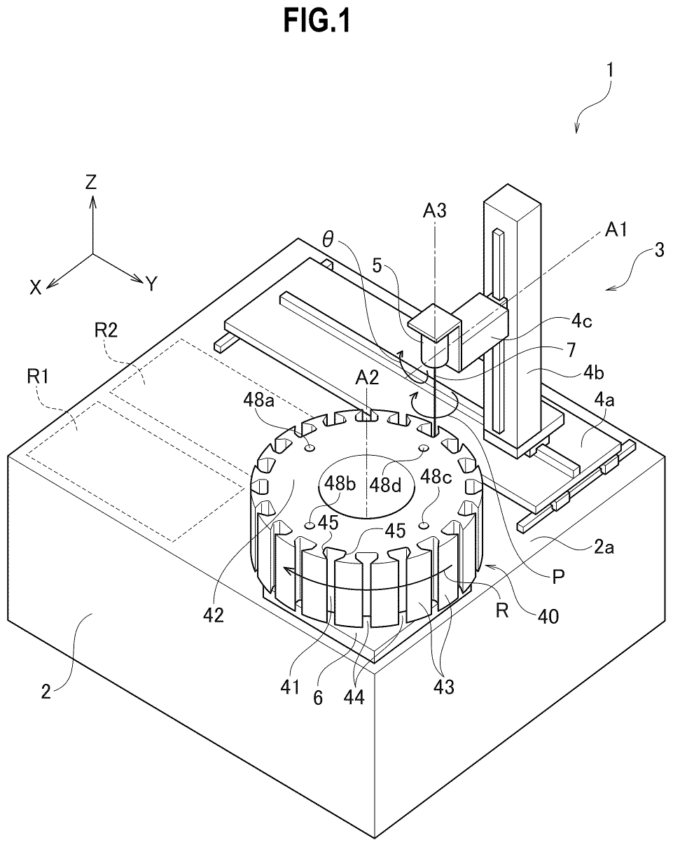

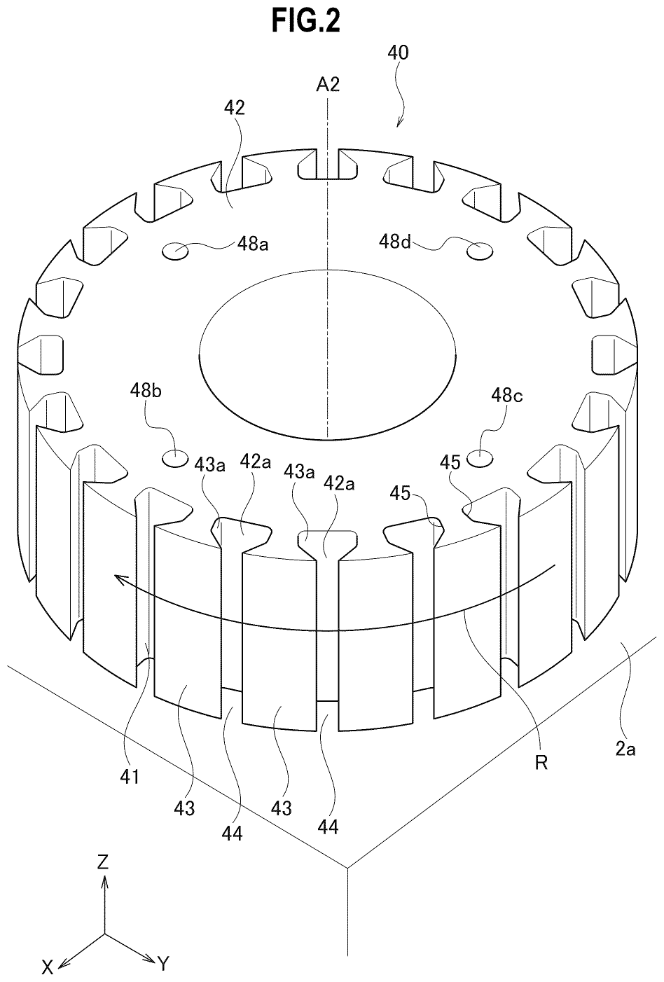

First, examples of the inspection device 1 and the inspection object will be described with reference to FIGS. 1 and 2. The inspection device 1 is an eddy-current flaw detection device for inspecting a component surface 41. The component surface 41 is a surface of a component 40 as the inspection object and is a surface to be subjected to the eddy-current flaw detection test. The component surface 41 may be a part of the entire surface of the component 40. The inspection device 1 performs an eddy-current flaw detection test to determine whether or not a defect exists on the component surface 41. The structure of the inspection device 1 is not limited to the structure illustrated in the figure, and the structure may be appropriately changed according to the shape, size, installation location of the inspection device 1, type of the component 40, etc.

As illustrated in FIG. 1, the inspection device 1 includes a frame 2 and a drive mechanism 3. The frame 2 is constituted by combining, for example, metal columns and beams. An upper surface 2a is formed on the upper portion of the frame 2. A component 40 (see FIG. 2) can be placed on the upper surface 2a. The upper surface 2a may extend substantially parallel to the XY plane.

The component 40 illustrated in FIGS. 1 and 2 has a substantially cylindrical shape as a whole. The component 40 is made of, for example, metal. When the component 40 is placed on the upper surface 2a, the central axis of the cylindrical shape may extend substantially parallel to the Z-axis direction. The component 40 has, for example, a body 42, projections 43, and slots 44.

The body 42 constitutes a part of the component 40 from the inner peripheral side of the component 40 to the outer peripheral side of the component 40. The projections 43 are arranged on the outer peripheral side of the body 42. That is, projections 43 and slots 44 are formed on the outer peripheral part of the component 40. The projections 43 are formed to extend outward in the radial direction of the component 40 from the body 42, and may extend vertically when the component 40 is placed on the upper surface 2a. Each of the projections 43 may be located on the circumference of the same circle around the axis A2 in plan view, and each of the projections 43 may be formed to be spaced at a predetermined interval in the R-axis direction. Slots 44 are formed between two of the projections 43 adjacent to each other. The slots 44 are groove portions extending vertically when the component 40 is placed on the upper surface 2a. Slots 44 may be formed at a predetermined interval in the R-axis direction on the outer periphery of the component 40. The shape, size or posture of the component 40 are not limited to the example shown in the figure.

The slot 44 is defined by an outer peripheral surface 42a of the body 42 and side surfaces 43a of the projections 43. The outer peripheral surface 42a forms a part of the outer peripheral portion of the body 42. The side surface 43a forms a part of the projection 43 in the R-axis direction.

The drive mechanism 3 is a mechanism for controlling the position or posture of the probe 10 or component 40, which will be described later. The drive mechanism 3 may be disposed at a predetermined position on the upper surface 2a. The drive mechanism 3 may have, for example, at least one of a first slider 4a, a second slider 4b, a third slider 4c, a holding member 5, and a stage 6.

The first slider 4a is a member movable in the X-axis direction in an area above the upper surface 2a. The first slider 4a may be a long metal member extending in the Y-axis direction. The first slider 4a may be movable in the X-axis direction by sliding along a rail extending in the X-axis direction disposed on the upper surface 2a, for example.

The second slider 4b is a member movable in the Y-axis direction in an area above the upper surface 2a. The second slider 4b may be a long metal member extending in the Z-axis direction. The second slider 4b may be movable in the Y-axis direction on the first slider 4a by sliding along a rail extending in the Y-axis direction disposed on the upper surface of the first slider 4a, for example.

The third slider 4c is a member movable in the Z-axis direction in an area above the upper surface 2a. The third slider 4c may be a member extending in the X-axis direction. The third slider 4c may be movable in the Z-axis direction by sliding along a rail extending in the Z-axis direction disposed on the second slider 4b, for example. The third slider 4c is attached to the second slider 4b to project in the X-axis positive direction from the X-axis positive side surface of the second slider 4b. A holding member 5 may be fixed to the end of the third slider 4c on the positive X-axis side.

The holding member 5 holds an end of the probe shaft 7, and in the state illustrated in FIG. 1, the probe shaft 7 extends from the holding member 5 in the negative Z-axis direction. A probe 10 (see FIG. 4) is attached to a tip of the probe shaft 7 on the negative Z-axis side. That is, the probe shaft 7 is a member connecting the holding member 5 and the probe 10. The holding member 5 may rotatably hold the probe shaft 7 around its extending direction. Thus, the holding member 5 can rotate the probe 10 in the P-axis direction. The holding member 5 may be fixed to the third slider 4c to be rotatable around the axis A1. Thus, it is possible to rotate the holding member 5 in the θ-axis direction around the axis A1 as the center axis. The axis A1 is an axis extending in the X-axis direction.

The stage 6 is a member capable of supporting the component 40 and is disposed in a predetermined region of the upper surface 2a. The stage 6 may be rotatable around the axis A2. That is, the stage 6 may rotatably support the component 40 about around axis A2. The axis A2 illustrated in FIG. 1 is an axis extending in the Z-axis direction, but is not limited thereto. For example, the axis A2 may be inclined with respect to the Z-axis.

With such a drive mechanism 3, for example, by adjusting the positions of the first slider 4a, the second slider 4b, and the third slider 4c, the positions of the probe 10 in the X-axis direction, the Y-axis direction, and the Z-axis direction can be adjusted. Also, by adjusting the rotation of the probe shaft 7 in the P-axis direction, the orientation of the coil 11 described later in the probe 10 can be adjusted. That is, the P-axis direction corresponds to the rotation direction around the rotation center axis of the probe 10. The angle of the probe 10 with respect to the Z-axis direction can be adjusted by adjusting the rotation of the holding member 5 in the θ-axis direction. The position of each part of the component 40 in the R-axis direction can be adjusted by adjusting the rotation around the axis A2 of the stage 6 while the component 40 is fixed to the stage 6. That is, the position or posture of the probe 10 or each part of the component 40 can be set to an arbitrary state by the drive mechanism 3. Thus, the eddy-current flaw detection test can be performed more accurately in accordance with the shape of the component 40.

The structure of the drive mechanism 3 is not limited to the illustrated example. The structure of the drive mechanism 3 can be appropriately changed according to the shape, dimensions, installation location of the inspection device 1, the type of the component 40, etc. The drive mechanism 3 can be adjusted in the X-axis direction, the Y-axis direction, the Z-axis direction, the P-axis direction, the θ-axis direction, and the R-axis direction, but is not limited thereto. The number of axes that can be adjusted by the drive mechanism 3 can be appropriately changed according to the shape, dimensions, installation location of the inspection device 1, the type of the component 40, etc.

A first imaging device used in the first recognition process described later may be disposed in a predetermined region of an upper surface 2a of the inspection device 1.

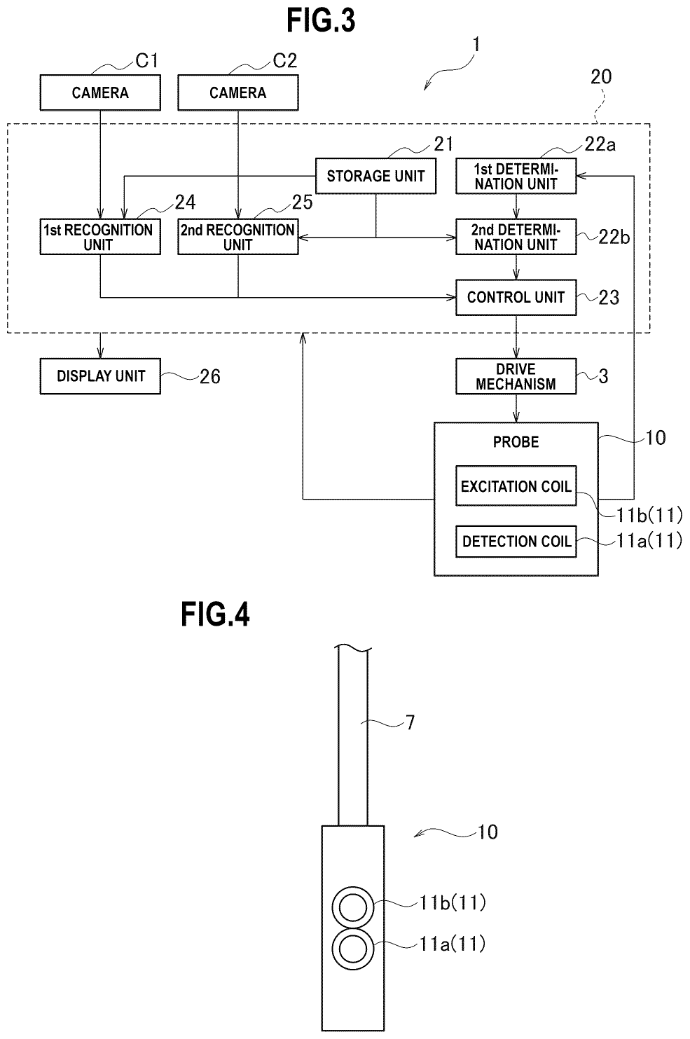

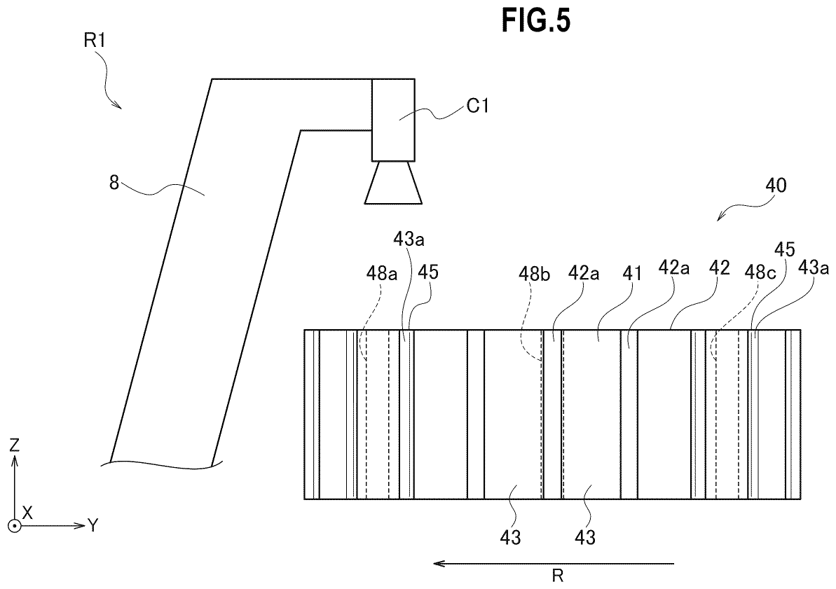

In the inspection device 1 illustrated in FIG. 1, for example, a camera C1 (see FIG. 5), which is the first imaging device, is disposed in a region R1 on the negative Y-axis direction side in the upper surface 2a with respect to the component 40. The camera C1 illustrated in FIG. 5 can photograph the region on the negative Z-axis side over time and generate an image. The camera C1 may be connected to the first recognition unit 24 of the controller 20 described later (see FIG. 3). The camera C1 may also output data of the image to the first recognition unit 24. The first imaging device is not limited to the camera C1, and a known imaging device may be used appropriately.

As illustrated in FIG. 5, the camera C1 may be supported by a support member 8 extending substantially in the vertical direction and fixed to the upper surface 2a. The camera C1 may be disposed above the component 40. Thus, the camera C1 can photograph the component 40 from above. The camera C1 may be movable between a position overlapping the region R1 and a position overlapping the component 40 in plan view. For example, the support member 8 may be arranged movably along a rail (not shown) extending in the Y-axis direction so that the camera C1 can move in the Y-axis direction.

The camera C1 may be provided with a light source (not shown) arranged in the vicinity thereof. The light source can emit light for imaging downward, and may be arranged adjacent to the camera C1, for example. The light source may be a light emitting diode capable of emitting blue light. Thus, in the first recognition process, the inspection device 1 can more reliably recognize the position of each part of the component 40.

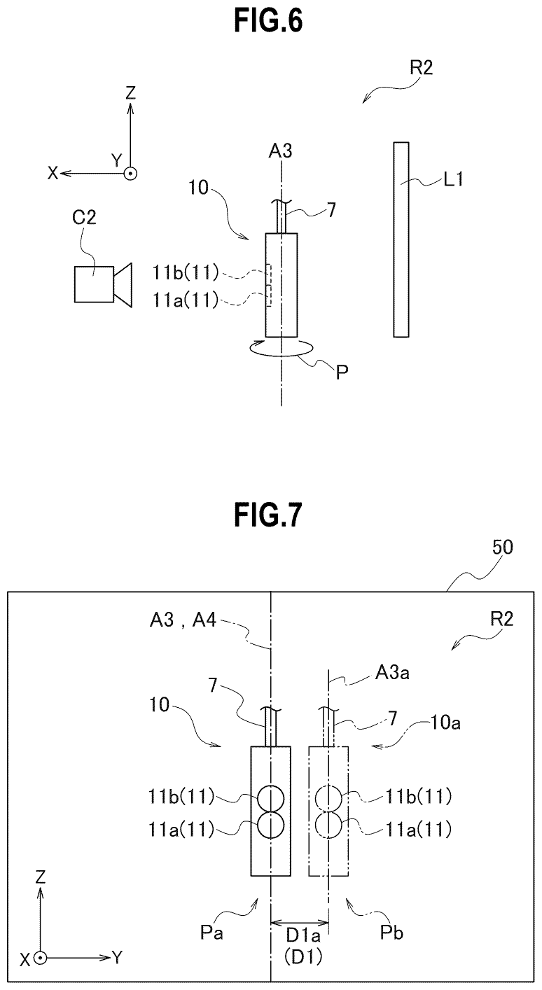

A second imaging device used in the second recognition process described later may be disposed in a predetermined region of the upper surface 2a of the inspection device 1. In the inspection device 1 illustrated in FIG. 1, for example, a camera C2 (see FIG. 6), which is the second imaging device, is disposed in a region R2 on the negative Y-axis direction side in the upper surface 2a with respect to the component 40. The camera C2 illustrated in FIG. 6 can photograph the region on the negative side of the X-axis over time and generate an image. The camera C2 may be an imaging device that photographs the probe 10 and generates an image of the probe 10. The camera C2 may be connected to the second recognition unit 25, which is a recognition unit of the controller 20 (see FIG. 3). The camera C2 may output data of the image to the second recognition unit 25. The second imaging device is not limited to the camera C2, and a known imaging device may be used appropriately.

The camera C2 may be supported by a support member (not shown) and fixed to the upper surface 2a. The camera C2 may be disposed facing in the negative X-axis direction, for example. A light source L1 may be disposed in the region R2. The light source L1 may be provided facing to the camera C2 in the X-axis direction, for example. The light source L1 illustrated in FIG. 6 can emit light for imaging toward the positive X-axis direction. The light source L1 may be a light-emitting diode capable of emitting blue light. Thus, in the second recognition process, the inspection device 1 can more reliably recognize the posture of the probe 10.

Next, an example of the configuration of the inspection device 1 will be described with reference to FIGS. 3 and 4. As illustrated in FIG. 3, the inspection device 1 includes a probe 10, a storage unit 21, a control unit 23, a first determination unit 22a, and a second determination unit 22b. The storage unit 21, the control unit 23, the first determination unit 22a, and the second determination unit 22b constitute a part of a controller 20 described later. The controller 20 may further include at least one of a first recognition unit 24 and a second recognition unit 25.

First, the probe 10 will be described. The probe 10 is a module that scans the surface of the inspection object along a predetermined scanning path and detects a change in eddy-current on the surface in the scanning path. The probe 10 is connected to the drive mechanism 3 via the probe shaft 7.

As illustrated in FIG. 4, the probe 10 has a substantially cylindrical shape extending in a direction parallel to the extending direction of the probe shaft 7. A coil 11 is disposed on the side portion of the probe 10. The coil 11 may include an excitation coil 11a and a detection coil 11b. The excitation coil 11a is a coil for generating eddy-current on the surface of the inspection object. The detection coil 11b is a coil for detecting the magnetic field induced by the eddy-current.

In the eddy-current flaw detection test, the probe 10 scans a predetermined scanning path. At this time, eddy-current is generated on the surface of the inspection object by the excitation coil 11a through which AC current flows. When a defect such as a crack exists in the inspection object, the eddy-current changes due to the effect of the defect. Therefore, the magnetic field induced by the eddy-current changes. This change in the magnetic field is detected by the detection coil 11b, and a signal indicating the change in eddy-current can be obtained.

In the example shown in FIG. 4, the excitation coil 11a and the detection coil 11b are directly adjacent to each other in the extending direction of the probe 10, and the detection coil 11b is disposed on the probe shaft 7 side of the excitation coil 11a. However, the position of the excitation coil 11a or the detection coil 11b in the probe 10 is not limited to the position shown in FIG. 4, and may be appropriately changed according to the shape of the inspection object, for example.

Next, the controller 20 will be described. As illustrated in FIG. 3, the controller 20 may include a storage unit 21, a control unit 23, a first recognition unit 24, a second recognition unit 25, a first determination unit 22a, and a second determination unit 22b. The controller 20 is a unit that performs processes necessary for the eddy-current flaw detection test. For example, the controller 20 may be a general-purpose microcomputer that includes a central processing unit (CPU), a memory, an input/output unit, and the like. In the memory of the microcomputer, a computer program including predetermined rules and instructions for processes of the eddy-current flaw detection test is installed. By executing the computer program, the microcomputer can perform the eddy-current flaw detection test. The controller 20 may be disposed, for example, in the inspection device 1.

The controller 20 controls the position or posture of the probe 10 when performing the eddy-current flaw detection test in the inspection device 1. The controller 20 may also acquire a signal indicating the change in eddy-current detected by the probe 10 and output information related to the signal to the display unit 26 described later.

The storage unit 21 stores in advance the shape of the component 40. That is, it stores component information, which is information on the shape or size of each part of the component 40, in advance. The component information may be stored in the storage unit 21 in advance before conducting the eddy-current flaw detection test on the component 40. For example, the component information can be stored by inputting data indicating the type of the component 40, the shape of each part, or the size of each part from an input unit (not shown) connected to the controller 20. The storage unit 21 may output the component information to the second determination unit. Furthermore, the storage unit 21 may output the component information to at least one of the first recognition unit 24 and the second recognition unit 25 described later.

The control unit 23 can control the position or posture of the probe 10 or the component 40. A drive mechanism 3 is connected to the control unit 23. The drive mechanism 3 sets the position or posture of the probe 10 or the component 40 based on a command output from the control unit 23. For example, the control unit 23 outputs various control values to the drive mechanism 3. The control value output to the drive mechanism 3 is, for example, a value (signal) for controlling the position, posture, or rotation of the first slider 4a, the second slider 4b, the third slider 4c, the holding member 5, or the stage 6. The control unit 23 may offset the scanning path P of the probe 10 in the scanning direction based on the offset amount D2 (described later) determined by the second determination unit.

The first recognition unit 24 is a recognition unit capable of recognizing the position of the component 40 in the first recognition process described later. A camera C1 is connected to the first recognition unit 24. In the first recognition process, the first recognition unit 24 recognizes the position of the component 40 in the inspection device 1 based on the image photographed by the camera C1. The first recognition unit 24 may output information related to the position of the component 40 to the control unit 23.

The first recognition unit 24 detects a characteristic part described later from the image obtained by imaging the component 40 from above with the camera C1, for example. The first recognition unit 24 can recognize the position of the characteristic part in the inspection device 1 by detecting the characteristic part. Here, the characteristic part is a part of the component 40 formed at a position which can be photographed with the camera C1. The characteristic part is, for example, a hole 48a of the component 40 (see FIG. 2). The hole 48a is an opening provided in an upper portion of the component 40. For example, when the component 40 is placed on the upper surface 2a, the hole 48a is formed in a cylindrical shape extending in the Z-axis direction.

The first recognition unit 24 recognizes the position of the characteristic part. The first recognition unit 24 can determine the position of the component 40 in the inspection device 1 by recognizing the position. The characteristic part of the component 40 is not limited to the hole 48a. That is, the first recognition unit 24 may determine the position of the component 40 by recognizing other portions of the component 40 as the characteristic part. When detecting the characteristic part from the image captured by the camera C1, a known technique can be applied. For example, the characteristic part may be detected in the image by applying an object recognition technique based on convolutional deep learning to the image.

The second recognition unit 25 is a recognition unit capable of recognizing the position or posture of the probe 10 in the second recognition process described later. The camera C2 is connected to the second recognition unit 25. In the second recognition process, the second recognition unit 25 recognizes the position or posture of the probe 10 in the inspection device 1 based on the image generated by the camera C2. Thus, the second recognition unit 25 can determine an offset amount D1 (described later), which is a second offset amount of the probe 10. The second recognition unit 25 can output information related to the offset amount D1 of the probe 10 to the control unit 23.

The second recognition unit 25 may detect the probe 10 from an image obtained by imaging the probe 10 from its side with the camera C2, for example. The second recognition unit 25 recognizes the position or posture of the probe 10 in the inspection device 1 by detecting the probe 10. When detecting the probe 10 from the image, a known technique can be applied. For example, the probe 10 may be detected in the image by applying an object recognition technique based on convolutional deep learning to the image.

The first determination unit 22a can obtain a signal indicating a change in eddy-current from the probe 10. The first determination unit 22a determines the position of an edge 45 in a scanning direction of the probe 10 based on an edge signal in the first determination process described later. The scanning direction is a direction in which a scanning path P described later extends, and corresponds to the Z-axis direction in the example shown in FIG. 9. The edge signal is a signal indicating a change in eddy-current generated by the edge 45 described later. The edge signal is a signal caused by an edge effect detected in the vicinity of the edge 45 when, for example, the side surface 43a of the projection 43 is scanned from below to above. Further, the first determination unit 22a may send information about the position of the edge 45 to the second determination unit 22b.

The second determination unit 22b can determine the offset amount D2 based on the information about the position of the edge 45 obtained from the first determination unit 22a. In the second determination process described later, the second determination unit 22b compares the position of the edge 45 with the position of the edge 45 of the component 40 stored in advance, and determines the offset amount D2 described later, which is a first offset amount in the scanning direction of the component 40. The second determination unit 22b may also send information related to the offset amount D2 to the control unit 23.

A display unit 26 may be connected to the controller 20. The display unit 26 may be, for example, a liquid crystal display or a touch panel display. The display unit 26 illustrated in FIG. 3 displays information related to a signal obtained by the eddy-current flaw detection test output from the controller 20. The information displayed on the display unit 26 is not particularly limited, and may display any information such as measurement conditions for conducting the eddy-current flaw detection test, information related to the component 40, and others.

Next, an operation example of the inspection device 1 will be described with reference to FIGS. 5 to 11. When performing the eddy-current flaw detection test in the inspection device 1, a position recognition process is performed before the inspection process. The inspection process is a process of inspecting the component 40 by an eddy-current flaw detection test.

### [Position Recognition Process]

In the position recognition process, for example, a first recognition process, a second recognition process, and an edge recognition process may be performed. Note that the processes performed in the position recognition process are not limited thereto. For example, in the position recognition process, at least one of the first recognition process, the second recognition process, and the edge recognition process may be performed.

### {First Recognition Process}

The first recognition process will be described with reference to FIG. 5. In the first recognition process, the first recognition unit 24 recognizes the position of the component 40 in the X-axis direction, the Y-axis direction, or the R-axis direction. In the illustrated example, the position of each part of the component 40 in the R-axis direction is determined by the first recognition unit 24, based on the hole 48a as the characteristic part. In the first recognition process, first, the camera C1 photographs the component 40 from above over time and generates an image. Then, the first recognition unit 24 detects the hole 48a in the image. The shape of the component 40 is stored in advance in the storage unit 21 of the controller 20. Therefore, the position of each part of the component 40 in the inspection device 1 can be determined by comparing the position of the hole corresponding to the hole 48a stored in the storage unit 21 with the position of the hole 48a detected by the first recognition unit 24.

In the first recognition process, the position of the hole 48a may be recognized by performing the first imaging process and the second imaging process. In the first imaging process, the camera C1 photographs the component 40 over time while rotating the component 40 in the R-axis direction. Then, the first recognition unit 24 recognizes the position of the hole 48a from each of the plurality of images obtained. Thus, the first recognition unit 24 can more accurately recognize the position of the hole 48a. Thereafter, the second imaging process is performed.

In the second imaging process, the camera C1 photographs the vicinity of the region where the hole 48a is recognized in the first imaging process of the component 40 with time while rotating the component 40 in the R-axis direction. Here, the angle range within which the component 40 is rotated in the second imaging process is smaller than the angle range within which the component 40 is rotated in the first imaging process. Then, the first recognition unit 24 recognizes the position of the hole 48a from each of the plurality of images obtained in the second imaging process. Thus, the first recognition unit 24 can more accurately recognize the hole 48a and its center position as viewed from above. The rotation of the component 40 in the R-axis direction can be controlled by the control unit 23 outputting a control value for controlling the rotation to the drive mechanism 3. As described above, by performing the first imaging process and the second imaging process, the first recognition unit 24 can more accurately recognize the hole 48a and the center of the hole 48a. Consequently, the inspection device 1 can more accurately determine the position of each part of the component 40 in the inspection device 1.

When the component 40 includes plural characteristic parts having substantially the same shape, the inspection device 1 may perform a predetermined operation on the component 40 to determine whether the shapes of each of the characteristic parts substantially overlap each other. In the component 40 illustrated in FIG. 2, holes 48b, 48c, and 48d are formed, for example. The holes 48b, 48c, and 48d have the same shape as the hole 48a. The holes 48a to 48d are arranged on the circumference of the same circle around the axis A2 in plan view. The holes 48a to 48d are arranged at predetermined intervals in the R-axis direction. In such a case, the component 40 is photographed by the camera C1 while being rotated in the R-axis direction by 90 degrees, for example, to generate plural images. Then, the first recognition unit 24 may detect the holes 48b, 48c, or 48d from each of the images, and further determine whether the holes 48b to 48d are detected at approximately the same position as the holes 48a. When the position of the hole 48a is correctly detected, the holes 48b to 48d will be detected at approximately the same position as the holes 48a. That is, by comparing the positions where the holes 48a to 48d are detected, it is possible to confirm whether the position of each part of the component 40 in the inspection device 1 is correctly determined. Thus, the position of each part of the component 40 in the inspection device 1 can be determined more accurately.

### {Second Recognition Process}

Next, the second recognition process will be described with reference to FIGS. 6 to 8. In the second recognition process, the second recognition unit 25 recognizes the position or posture of the probe 10 from the image generated by the camera C2 and determines the offset amount D1. The offset amount D1 is a value indicating the deviation (shift) of the probe 10 from the reference position. The second recognition unit 25 may determine the offset amount D1 by comparing the position at which the probe 10 is detected in the image with the reference position of the probe 10 in the image. The offset amount D1 may be a value indicating the deviation (shift) of the probe 10 from the reference position in the direction crossing the scanning direction of the probe 10. The offset amount D1 illustrated in FIG. 7 indicates the deviation of the probe 10 from the reference position in the direction perpendicular to the Z-axis direction. The reference position of the probe 10 may be stored in the second recognition unit 25. The second recognition unit 25 may perform a predetermined operation on the probe 10 and recognize the position or posture of the probe 10 based on the image of the probe 10 photographed by the camera C2. The predetermined operation may be an operation to rotate the probe 10 about the axis A3. The axis A3 is the rotation axis of the probe 10, and in the illustrated example, it extends in a direction parallel to the Z-axis direction. The probe shaft 7 extends in a direction substantially parallel to the axis A3, and the probe shaft 7 has the axis A3 as the rotation axis. Therefore, the control unit 23 can control the rotation of the probe 10 in the P-axis direction by controlling the rotation of the probe shaft 7 around the axis A3.

In the example shown in FIG. 6, the probe 10 is located between the camera C2 and the light source L1 in the region R2. The probe 10 may be positioned so that the coil 11 faces in the positive X-axis direction. That is, the probe 10 may be arranged so that the camera C2 and the coil 11 face each other in the X-axis direction. By imaging in the illustrated state, an image 50 (see FIG. 7) is obtained. The image 50 represents a state in which the probe 10 shown in FIG. 6 is viewed from the positive X-axis direction. In FIG. 7, the display of the light source L1 is omitted.

Next, the second recognition unit 25 detects the probe 10 in the image 50 and recognizes the position or posture of the probe 10 in the inspection device 1. The probe 10 shown by the solid line in FIG. 7 is detected at the position Pa in the image 50. The axis A3 passing through the center of the probe 10 in the Y-axis direction and the reference axis A4 coincide with each other. In this case, the offset amount D1 becomes 0. The reference axis A4 is a reference axis for determining the offset amount D1. The position or posture of the reference axis A4 in the image taken by the camera C2 is not limited to the illustrated example, and may be arbitrarily set. The reference used for determining the offset amount D1 is not limited to the reference axis A4, but may be, for example, a predetermined point or a predetermined region.

For example, when a part of the probe shaft 7 is slightly curved, the probe 10 is detected at a position shifted from a reference position in the image 50. For example, the probe 10 is detected at position Pb, which is a region in the positive direction of the Y-axis from the position Pa. The probe 10a illustrated by a broken line in FIG. 7 is the probe 10 detected at position Pb. The axis A3a passing through the center of the probe 10a in the Y-axis direction is separated from the reference axis A4.

In the state illustrated in FIG. 7, the distance between the axis A3, which is the rotation axis of the probe 10a, and the reference axis A4 corresponds to the offset amount D1a. Specifically, the offset amount D1 may be determined by comparing the axis A3 of the probe 10 with the reference axis A4 in the image generated by the camera C2. In this case, the offset amount D1 may be determined based on the distance between the axis A3 and the reference axis A4. The offset amount D1a is the offset amount D1 of the probe 10a when the coil 11 faces the positive X-axis direction. By determining such an offset amount D1, the position of the probe 10 in the inspection device 1 can be determined more accurately.

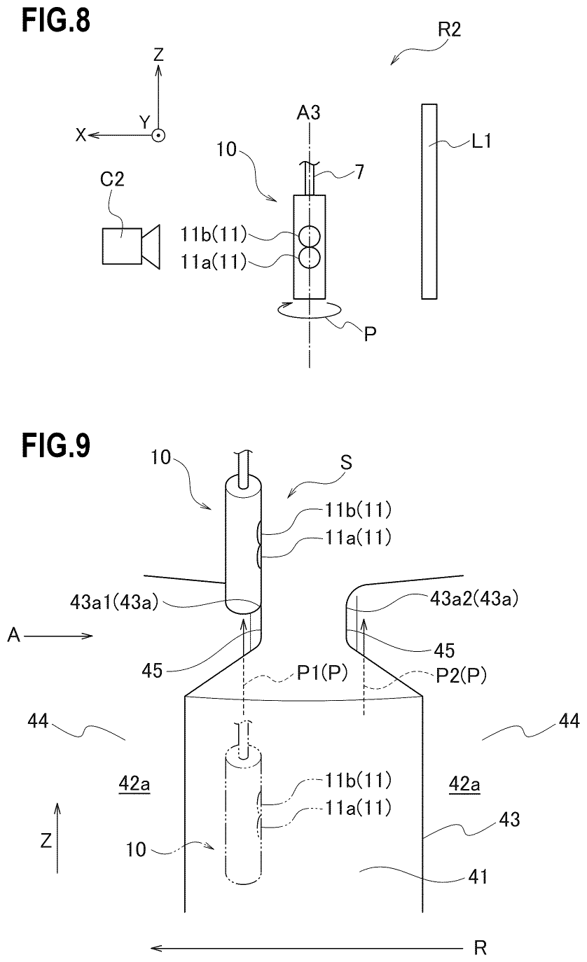

In the second recognition process, the probe 10 may be rotated from the state shown in FIG. 6, and the offset amount D1 may be determined. For example, the probe illustrated in FIG. 8 is located between the camera C2 and the light source L1 in a state where the probe 10 is rotated by a predetermined angle in the P-axis direction from the state illustrated in FIG. 6. The probe 10 illustrated in FIG. 8 is arranged so that the coil 11 faces toward the positive Y-axis direction, for example. However, the orientation of the coil 11 is not limited to the example shown in FIG. 8. That is, the orientation of the probe 10 can be arbitrarily set.

By imaging in the state illustrated in FIG. 8, an image corresponding to the image 50 of the probe 10 with the coil 11 facing toward the positive Y-axis direction can be obtained. The second recognition unit 25 detects the probe 10 from the obtained image and recognizes the position or posture of the probe 10 in the inspection device 1. The second recognition unit 25 determines the offset amount D1 of the probe 10 based on the position or posture of the probe 10 detected from the image. Thus, the offset amount D1 of the probe 10 in which the coil 11 faces toward the positive Y-axis direction can be determined. That is, the second recognition unit 25 can determine the offset amount D1 in each of the arrangements in which the directions of the probes 10 are different. Therefore, the position of the probe 10 in the inspection device 1 of the probe 10 can be determined more accurately.

### {Edge Recognition Process}

Next, the edge recognition process will be described with reference to FIGS. 9 to 11. In the edge recognition process, a first scanning process, a first determination process, and a second determination process are performed. Hereinafter, the edge recognition process will be described with reference to a side surface 43a1 forming the left side portion in FIG. 9 of the side surface 43a of the projection 43 as an example.

### (First Scanning Process)

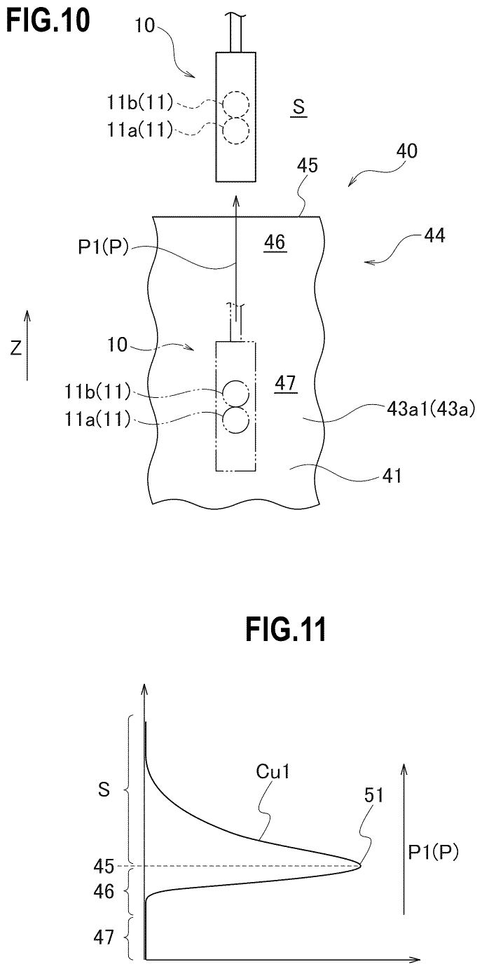

First, the first scanning process will be described with reference to FIGS. 9 and 10. In the first scanning process, the control unit 23 causes the probe 10 to scan the component surface 41 along a scanning path P, and the probe 10 detects a change in eddy-current. The scanning path P is a path of the probe 10 across the edge 45 of the component surface 41.

As illustrated in FIG. 9, the component 40 includes the edge 45. The edge 45 is an upper edge of the side surface 43a. As illustrated in FIG. 10, an edge region 46 extends near the edge 45 in the side surface 43a. The edge region 46 extends in a predetermined range along the edge 45 on the negative Z-axis direction side of the edge 45. The dimension of the edge region 46 in the Z-axis direction is, for example, 1 mm to 5 mm. A first region 47 is formed in a region directly adjacent to the edge region 46 in the side surface 43a. As described above, the component surface 41 has the edge region 46 extending along the edge 45 and the first region 47 adjacent to the edge region 46. The edge region 46 and the first region 47 illustrated in FIG. 10 do not have defects such as cracks.

In the example shown in FIG. 9, the probe 10 scans along a scanning path P1, and detects a change in eddy-current. The scanning path P1 is a scanning path P extending across the edge 45, which constitutes the upper portion of the side surface 43a1. The scanning path P1 may be a path from below to above. When scanning along the scanning path P1, the probe 10 may be moved so that the coil 11 contacts the side surface 43a1.

In the first scanning process, the control unit 23 may control the position of the probe 10 based on the offset amount D1 determined by the second recognition unit 25. That is, the control unit 23 may offset the position of the probe 10 based on the offset amount D1. For example, the control unit 23 may offset the scanning path of the probe 10 in the direction crossing the scanning direction based on the offset amount D1. This can prevent excessive gap from being formed between the probe 10 and the side surface 43a1. Moreover, excessive pressing of the probe 10 against the side surface 43a1 can be prevented, and the risk of deformation of the probe shaft 7, for example, can be reduced. The direction in which the probe 10 is offset is not particularly limited, and may be, for example, the X-axis direction or the Y-axis direction.

In the first scanning process, when the probe 10 scans along the scanning path P1, the first region 47, the edge region 46, and the space S are subjected to the eddy-current flaw detection test. The space S is a space located above the edge region 46. In the example shown in FIGS. 9 and 10, first, the probe 10 scans from the first region 47 to the edge region 46, and then scans from the edge region 46 to the space S.

### (First Determination Process)

Next, the first determination process will be described with reference to FIGS. 10 and 11. In the first determination process, the first determination unit 22a determines the position of the edge 45 in the scanning direction based on the edge signal. The scanning direction is a direction in which the scanning path P extends, and corresponds to the Z-axis direction in the example shown in the figure. The edge signal is a signal indicating a change in eddy-current caused by the edge 45.

The graph in FIG. 11 illustrates the intensity of the signal detected by the probe 10 at each position along the scanning path P1. The horizontal axis of the graph represents the intensity of the signal indicating a change in eddy-current, and the vertical axis represents each position in the scanning path P1. The inspection device 1 may detect the intensity of the signal indicating a change in eddy-current as, for example, a voltage (V).

There is no defect in the first region 47 illustrated in FIG. 10. Therefore, when the probe 10 scans the first region 47 along the scanning path P1, the eddy-current does not change. Moreover, the signal intensity in the range corresponding to the first region 47 in FIG. 11 is close to 0.

The edge region 46 also has no defect. Therefore, when the probe 10 scans the edge region 46 along the scanning path P1 from below to above, the eddy-current does not change in the region near the first region 47 in the edge region 46. In the range corresponding to this region, the signal intensity is close to 0. Thereafter, the probe 10 scans the edge region 46 from below toward the edge 45. Here, an edge signal, which is a signal caused by an edge effect, is detected in the vicinity of the edge 45. Therefore, the signal intensity detected by the probe 10 increases. The edge effect is a phenomenon in which, when the vicinity of the edge of the component 40 is scanned in the eddy-current flaw detection test, the flow path of eddy-current generated on the surface of the component 40 changes due to the presence of the edge, and a relatively strong signal indicating the change is detected.

Next, the probe 10 scans the space S along the scanning path P1. As the coil 11 moves upward in the space S, the coil 11 moves away from the edge 45, and the influence of the edge effect gradually decreases. That is, although an edge signal is detected in the region near the edge 45 in the space S, the intensity of the edge signal gradually decreases as the coil 11 moves upward. When the probe 10 scans the space S, there is no conductor facing the coil 11 in the extension direction of the central axis of the coil 11 near the coil 11. Therefore, in the region sufficiently far from the edge 45 in the space S, the intensity of the signal indicating the change of the eddy-current is close to 0. Thus, the intensity curve Cu1 indicating the intensity of the signal at each position of the scanning path P1 is obtained.

As described above, the edge signal may be detected by scanning the space S from the first region 47 along the scanning path P1 with the probe 10. That is, the edge signal may be detected by scanning the probe 10 from the first region 47 across the edge region 46 toward the outside of the edge 45.

In the first determination process, the position of the edge 45 may be determined based on the portion of the intensity curve Cu1 showing the change of the eddy-current caused by the edge 45. The peak 51 exists in the intensity curve Cu1. In the first determination process, the position corresponding to the peak 51 in the scanning path P1 may correspond to the position of the edge 45 in the Z-axis direction. In other words, the first determination unit 22a may determine the position of the edge 45 in the scanning direction where the intensity of the signal showing the change of the eddy-current becomes maximum when the probe 10 scans the component surface 41 along the scanning path P. The method for determining the position of the edge 45 in the scanning direction is not limited to the above-described method. For example, the first determination unit 22a may determine a position corresponding to the edge signal detected on the negative Z-axis direction side or the positive Z-axis direction side of the peak 51 as the position of the edge 45. Furthermore, for example, a method for associating the intensity curve Cu1 with the position of the edge 45 may be appropriately set depending on the structure of the probe 10 or the arrangement of the coil 11.

### (Second Determination Process)

Next, the second determination process will be described. In the second determination process, the second determination unit 22b compares the position of the edge 45 determined in the first determination process with the position of the edge, which corresponds to the edge 45, of the component 40 stored in advance and determines the offset amount. The offset amount is a value indicating the deviation (shift) of the component 40 from the reference position of the component 40 in the scanning direction. This offset amount is referred to as the offset amount D2.

The shape of the component 40 is stored in advance in the storage unit 21 of the controller 20. Therefore, the position of the edge 45 in the inspection device 1 can be determined more accurately by comparing the position of the edge 45 determined in the first determination process with the position of the edge corresponding to the edge 45 stored in the storage unit 21.

In the example shown in FIGS. 9 to 11, the position of the edge 45 in the Z-axis direction is determined by the first determination unit 22a. Therefore, the offset amount D2 in the Z-axis direction of the edge 45 can be determined by comparing the position of the edge 45 determined by the first determination unit 22a with the position of the edge corresponding to the edge 45 stored in the storage unit 21. The offset amount D2 may be a deviation of the position of the edge 45, which is determined by the first determination unit 22a, from a position of an edge in the Z-axis direction as a reference. Here, the edge corresponds to the edge 45 and is assumed when a component corresponding to the component 40 stored in the storage unit 21 is placed on the inspection device 1. By determining the offset amount D2, the position of the component 40 in the scanning direction of the scanning path P can be determined more accurately.

In the edge recognition process, after the first scanning process, the first determination process, and the second determination process are performed on the side surface 43a1, the first scanning process, the first determination process, and the second determination process may be performed on the side surface 43a2 (see FIG. 9) in the same manner as the case of the side surface 43a1. The side surface 43a2 forms the right side portion in FIG. 9 of the side surface 43a of the projection 43. Thus, the offset amount D2 in the Z-axis direction of the edge 45 forming the upper side of the side surface 43a2 can be determined. That is, in the edge recognition process, the first scanning process, the first determination process, and the second determination process may be performed on plural surfaces.

When determining the offset amount D2 of each of the side surfaces 43a1 and 43a2, the control unit 23 may cause the probe 10 to scan the side surface 43a1 along the scanning path P1 and the probe 10 to scan the side surface 43a2 along the scanning path P2 (see FIG. 9). In other words, the control unit 23 may cause the probe 10 to scan the side surface 43a1 and the side surface 43a2 along the scanning path P. Here, the side surface 43a1 forms a part of the projection 43 on one side in the R-axis direction, the side surface 43a2 forms a part of the projection 43 opposite to the side surface 43a1, and the projection 43 constitutes the component 40. The scanning path P2 is a scanning path P extending across the edge 45 forming the upper portion of the side surface 43a2, and corresponds to the scanning path P1 of the side surface 43a1.

Further, the first determination unit 22a may determine a position of an edge in the scanning direction in each of a surface forming a part of a first portion on one side in a first direction and a surface forming a part of the first portion opposite to the surface, based on the edge signal. For example, the first determination unit 22a may determine the position of the edge 45 in the scanning direction in each of the side surface 43a1 and the side surface 43a2, based on the edge signal. The first portion is not limited to the projection 43, and may be appropriately selected depending on the shape of the component 40, for example. The first direction is not limited to the R-axis direction, and may be appropriately set depending on the shape of the first portion, for example.

The first determination unit 22a may determine the position of the edge 45 of the projection 43 based on the first edge signal and the second edge signal. The first edge signal is an edge signal detected when the probe 10 scans the side surface 43a1 along the scanning path P1. The second edge signal is an edge signal detected when the probe 10 scans the side surface 43a2 along the scanning path P2. For example, the first determination unit 22a may determine the position of the edge 45 of the projection 43 in the Z-axis direction by calculating the average value of the coordinates of the position of the edge 45 in the Z-axis direction determined based on the first edge signal and the coordinates of the position of the edge 45 in the Z-axis direction determined based on the second edge signal. Thus, the first determination unit 22a can more accurately determine the position of the edge 45 in the scanning direction.

In the edge recognition process, the first scanning process, the first determination process, and the second determination process may be performed for each of projections 43 formed in the component 40. That is, the control unit 23 may scan the probe 10 along the scanning path P for each of the projections 43 forming the component 40. The first determination unit 22a may determine the position of the edge 45 in the scanning direction in each of the projections 43 based on the edge signal. The first determination unit 22a may determine whether the position of the peak 51, which has the maximum intensity, of the edge signal in the scanning direction for each of the projections 43 is within a predetermined range. The second determination unit 22b may compare the position of the edge 45 in the scanning direction of each of the projections 43 with the position of the edge corresponding to the edge 45 stored in advance in the storage unit 21. Then, the offset amount D2 in the scanning direction of the edge 45 may be determined for each of the projections 43.

Thus, the inspection device 1 can more accurately determine the position of the edge 45 in each of the projections 43 forming the component 40. Furthermore, by determining whether or not the position of the edge 45 is within a predetermined range, it can be determined whether or not the component 40 is placed substantially in parallel in the inspection device 1. The projections 43 for which the position of the edge 45 is determined may be projections 43 formed at a predetermined position in the component 40. For example, the position of the edge 45 may be determined for each of the three projections 43 selected from the plurality of projections 43 illustrated in FIG. 2. The three projections 43 may be selected so that the distance between them in the R-axis direction becomes larger.

### [Inspection Process]

In the eddy-current flaw detection test using the inspection device 1, the inspection process is performed after the position recognition process described above. In the inspection process, the eddy-current flaw detection test on the component 40 is performed while the control unit 23 controls the position or posture of the probe 10 based on the information obtained in the position recognition process. That is, the component surface 41 is scanned by the probe 10, and a signal indicating a change in eddy-current is detected.

In the inspection process, the control unit 23 may control the position or posture of the probe 10 in the eddy-current flaw detection test, based on the offset amount D1 of the probe 10 or the offset amount D2 of the component 40 acquired in the position recognition process. For example, when performing an eddy-current flaw detection test on the side surface 43a, the control unit 23 may offset the position of the probe 10 based on the offset amount D1. Thus, formation of an excessive gap between the probe 10 and the side surface 43a1 can be suppressed. Furthermore, excessive pressing of the probe 10 against the side surface 43a1 can be suppressed, and the risk of deformation of the probe shaft 7, for example, can be reduced. The direction in which the probe 10 is offset is not particularly limited, and may be, for example, the X-axis direction or the Y-axis direction.

Further, the control unit 23 may offset the position of the probe 10 based on the offset amount D2. For example, when performing an eddy-current flaw detection test on the side surface 43a, the control unit 23 may offset the scanning path P scanned by the probe 10 in the Z-axis direction, which is the scanning direction, based on the offset amount D2. Thus, the inspection device 1 can perform scanning in the Z-axis direction more accurately.

Next, the eddy-current flaw detection device according to the embodiment and the effects of the eddy-current flaw detection method will be described.

(1) The eddy-current flaw detection device 1 according to the embodiment includes: the storage unit 21 which stores in advance the shape of the first object 40 to be inspected; and the probe 10 which scans the component surface 41 of the first object 40 and detects a change in eddy-current. The device includes the control unit 23 which causes the probe 10 to scan the component surface 41 along the scanning path P that crosses the edge 45 of the component surface 41. The device includes the first determination unit 22a which determines the position of the edge 45 in the scanning direction in which the scanning path P extends, based on the edge signal indicating a change in eddy-current caused by the edge 45. The device includes the second determination unit 22b which compares the position of the edge with a position of an edge of the first object 40 stored in advance and determines the first offset amount D2 in the scanning direction of the first object 40. The control unit 23 offsets the scanning path P in the scanning direction based on the offset amount D2 (first offset amount).

According to the eddy-current flaw detection device according to the embodiment, the inspection device 1 can more accurately determine, for example, the position of the edge 45 in the positive Z-axis direction. That is, the inspection device 1 can more accurately determine the position of the component 40 in the scanning direction in advance when performing the eddy-current flaw detection test. When performing the eddy-current flaw detection test on the component 40, the scanning path P of the probe 10 is offset in the scanning direction. Therefore, the inspection device 1 can more accurately perform the eddy-current flaw detection test.

(2) The edge signal may be detected by scanning the probe 10 from the first region 47 adjacent to the edge region 46 extending along the edge 45 on the component surface 41 toward the outside of the edge across the edge region 46.

Thus, for example, when scanning along the scanning path P, the probe 10 can more reliably detect the edge signal near the edge 45. Accordingly, the inspection device 1 can more accurately determine the position of the component 40 in the scanning direction in advance when performing the eddy-current flaw detection test.

(3) The first determination unit 22a may determine, as the position of the edge 45 in the scanning direction, the position where the intensity of the signal indicating the change in eddy-current becomes maximum when scanning the component surface 41 with the probe 10 along the scanning path P.

Thus, for example, the position of the edge 45 in the scanning direction can be determined more reliably based on the edge signal obtained by scanning the scanning path P.

(4) The control unit 23 may cause the probe 10 to scan one side surface 43a1 of the first portion 43 and the other side surface 43a2 thereof in the first direction, which form the first object 40, along the scanning paths P1 and P2. The first determination unit 22a may determine the position of the edge 45 in the scanning direction of each of the one side surface 43a1 and the other side surface 43a2 based on the edge signal.

Thus, the first determination unit 22a, for example, can determine the position of the edge 45 of the projection 43 based on the position of the edge 45 determined by scanning the side surface 43a1 and the position of the edge 45 determined by scanning the side surface 43a2. Therefore, the first determination unit 22a can more accurately determine the position of the edge 45 in the scanning direction.

(5) The control unit 23 may cause the probe 10 to scan each of the first portions 43 forming the first object 40 along the scanning path P. The first determination unit 22a may determine the position of the edge 45 in the scanning direction of each of the first portions 43 based on the edge signal.

Thus, the inspection device 1 can determine the position of the edge 45 in each of the projections 43 forming the component 40. Therefore, the position of the component 40 in the inspection device 1 can be more accurately determined.

The first determination unit 22a may determine whether the position of the peak 51, which has the maximum intensity, of the edge signal in the scanning direction for each of the projections 43 is within a predetermined range. Thus, the inspection device 1 can determine whether the component 40 is placed substantially in parallel.

(6) The eddy-current flaw detection device 1 may include the imaging device C2 that photographs the probe 10 and generates an image 50, and the recognition unit 25 that detects the probe 10 in the image 50 generated by the imaging device C2 and recognizes the position or posture of the probe 10. The recognition unit 25 may determine the offset amount D1 (second offset amount) in the direction crossing the scanning direction of the probe 10 by comparing the position at which the probe is detected in the image 50 with the reference position of the probe therein. The control unit 23 may offset the scanning path P in the direction crossing the scanning direction based on the offset amount D1 (second offset amount).

Thus, for example, it is possible to suppress the formation of an excessive gap between the probe 10 and the side surface 43a1. Moreover, it is possible to suppress the excessive pressing of the probe 10 against the side surface 43a1. Therefore, the inspection device 1 can perform the eddy-current flaw detection test more accurately and reduce the risk of deformation of the probe shaft 7, for example.

(7) In the eddy-current flaw detection method according to the embodiment, the shape of the first object 40 to be inspected is stored in advance, and by the probe 10, the component surface 41 of the first object 40 is scanned and a change in eddy-current is detected. In this method, the component surface 41 is scanned by the probe 10 along the scanning path P which crosses the edge 45 of the component surface 41. In this method, the position of the edge 45 in the scanning direction in which the scanning path P extends is determined based on the edge signal indicating the change in eddy-current caused by the edge 45. In this method, the position of the edge 45 is compared with the position of the edge of the first object 40 stored in advance and the first offset amount D2 in the scanning direction of the first object 40 is determined. In this method, the scanning path P is offset in the scanning direction based on the offset amount D2 (first offset amount).

According to the eddy-current flaw detection method according to the embodiment, when performing the eddy-current flaw detection test, for example, the position of the edge 45 in the positive Z-axis direction can be more accurately determined. That is, the eddy-current flaw detection test can be performed after the position of the component 40 in the scanning direction is more accurately determined in advance. When performing the eddy-current flaw detection test of the component 40, the scanning path P of the probe 10 is offset in the scanning direction. Therefore, the eddy-current flaw detection test can be performed more accurately.

The present disclosure can contribute to, for example, Goal 9 “Building resilient infrastructure, promoting inclusive and sustainable industrialization, and promoting innovation” of the Sustainable Development Goals (SDGs).

Although some embodiments have been described above, the embodiments can be modified or modified based on the above disclosure. All components of the above embodiments and all features described in the claims may be individually extracted and combined as long as they are consistent with each other.

What is claimed is:

1. An eddy-current flaw detection device comprising:
a storage unit configured to store in advance a shape of a first object to be inspected;
a probe configured to scan a component surface of the first object and to detect a change in eddy-current;
a control unit configured to cause the probe to scan the component surface along a scanning path that crosses an edge of the component surface;
a first determination unit configured to determine a position of the edge in a scanning direction in which the scanning path extends, based on an edge signal indicating the change in eddy-current caused by the edge; and
a second determination unit configured to compare the position of the edge with a position of an edge of the first object stored in advance and to determine a first offset amount in the scanning direction of the first object; wherein
the control unit offsets the scanning path in the scanning direction based on the first offset amount.

2. The eddy-current flaw detection device according to claim 1, wherein
the edge signal is detected by scanning the probe from a first region adjacent to an edge region extending along the edge on the component surface toward an outside of the edge across the edge region.

3. The eddy-current flaw detection device according to claim 2, wherein
the first determination unit determines, as the position of the edge in the scanning direction, a position where an intensity of the signal indicating the change in eddy-current becomes maximum when scanning the component surface with the probe along the scanning path.

4. The eddy-current flaw detection device according to claim 1, wherein
the control unit causes the probe to scan one side surface of a first portion and the other side surface thereof in the first direction, which form the first object, along the scanning path; and
the first determination unit determines the position of the edge in the scanning direction of each of the one side surface and the other side surface based on the edge signal.

5. The eddy-current flaw detection device according to claim 2, wherein
the control unit causes the probe to scan one side surface of a first portion and the other side surface thereof in the first direction, which form the first object, along the scanning path; and
the first determination unit determines the position of the edge in the scanning direction of each of the one side surface and the other side surface based on the edge signal.

6. The eddy-current flaw detection device according to claim 3, wherein
the control unit causes the probe to scan one side surface of a first portion and the other side surface thereof in the first direction, which form the first object, along the scanning path; and
the first determination unit determines the position of the edge in the scanning direction of each of the one side surface and the other side surface based on the edge signal.

7. The eddy-current flaw detection device according to claim 1, wherein
the control unit causes the probe to scan each first portion forming the first object along the scanning path, and
the first determination unit determines the position of the edge in the scanning direction of each first portion based on the edge signal.

8. The eddy-current flaw detection device according to claim 2, wherein
the control unit causes the probe to scan each first portion forming the first object along the scanning path, and
the first determination unit determines the position of the edge in the scanning direction of each first portion based on the edge signal.

9. The eddy-current flaw detection device according to claim 3, wherein
the control unit causes the probe to scan each first portion forming the first object along the scanning path, and
the first determination unit determines the position of the edge in the scanning direction of each first portion based on the edge signal.

10. The eddy-current flaw detection device according to claim 1, further comprising:
an imaging device configured to photograph the probe and to generate an image; and
a recognition unit configured to detect the probe in the image generated by the imaging device and to recognize a position or posture of the probe; wherein
the recognition unit determines a second offset amount in a direction crossing the scanning direction of the probe by comparing the position at which the probe is detected in the image with a reference position of the probe therein, and
the control unit offsets the scanning path in the direction crossing the scanning direction based on the second offset amount.

11. The eddy-current flaw detection device according to claim 2, further comprising:
an imaging device configured to photograph the probe and to generate an image; and
a recognition unit configured to detect the probe in the image generated by the imaging device and to recognize a position or posture of the probe; wherein
the recognition unit determines a second offset amount in a direction crossing the scanning direction of the probe by comparing the position at which the probe is detected in the image with a reference position of the probe therein, and
the control unit offsets the scanning path in the direction crossing the scanning direction based on the second offset amount.

12. The eddy-current flaw detection device according to claim 3, further comprising:
an imaging device configured to photograph the probe and to generate an image; and
a recognition unit configured to detect the probe in the image generated by the imaging device and to recognize a position or posture of the probe; wherein
the recognition unit determines a second offset amount in a direction crossing the scanning direction of the probe by comparing the position at which the probe is detected in the image with a reference position of the probe therein, and
the control unit offsets the scanning path in the direction crossing the scanning direction based on the second offset amount.

13. An eddy-current flaw detection method comprising:
storing in advance a shape of a first object to be inspected;
by a probe, scanning a component surface of the first object and detecting a change in eddy-current;
causing the probe to scan the component surface along a scanning path which crosses an edge of the component surface;
determining a position of the edge in a scanning direction in which the scanning path extends, based on the edge signal indicating the change in eddy-current caused by the edge;
comparing the position of the edge with a position of an edge of the first object stored in advance and determining a first offset amount in the scanning direction of the first object; and
offsetting the scanning path in the scanning direction based on the first offset amount.
